(19) United States
(12) Patent Application Publication
(10) Pub. No.: US 2005/0122328 A1
(43) Pub. Date: Jun. 9, 2005

(54) Method and apparatus for specifying animation styles

(76) Inventors: Peiya Liu, East Brunswick, NJ (US); Young Francis Day, Plainsboro, NJ (US); Liang H. Hsu, West Windsor, NJ (US)

Correspondence Address: Siemens Corporation;Intellectual Property Department, 170 Wood Avenue South, Iselin, NJ, 08830, US

(21) Appl. No.: 10/728,545

(22) Filed: Dec. 5, 2003

(51) Int. Cl. G06T 15/00

(52) U.S. Cl. 345/474; 345/473

(57) ABSTRACT

A method for specifying animation by a computer for a drawing illustration includes the steps of: loading a first image into an animation author for display on a display screen; entering an animation object into said animation author; entering into said animation author an animation path for said animation object from a starting position to an end position; and entering into said animation author a playback speed for playback of said animation.

The present invention relates to the specification of animations and, more specifically, to a method and apparatus for specifying advanced animation styles.

### BACKGROUND OF THE INVENTION

Software tools, such as ToolBook™, are available for enabling easy creation of high-quality, standards based e-learning content without much specialized knowledge. Relatively fast authoring is thereby made possible, where the user typically simply points, clicks and drags objects onto a page. For further information on ToolBook™, see http://www.asymetrix.com/.

### BRIEF SUMMARY OF THE INVENTION

The present invention provides a method and apparatus for specifying advanced animations such as for engineering drawing illustrations using ToolBook™.

It is herein recognized that support for animation in tools such as ToolBook™ is limited. Thus, ToolBook™ does not provide support for fluid/pipe type animation, animation with orientation, nor for synchronization among animation objects. Many other non-ToolBook™ based approaches such as JAVA need to specify animation using programs instead of specifications and are therefore herein recognized as not being well suited for animating complex engineering illustrations. JAVA is a programming language from Sun Microsystems designed primarily for writing software to leave on Internet Web sites and downloadable over the Internet to a computer. For further information on JAVA, see http://www.sun.com/.

In accordance with an aspect of the present invention, an animation authoring tool is developed for a user for interactively drawing/specifying regular animation, animation with orientation, fluid/pipe animation, and animation with scheduling.

In accordance with another aspect of the present invention, the user can specify an animation simply by creating/selecting an object and drawing its path (projectory) on the illustration. The specified animation can then be saved as a Toolbook™ book or an SGML file. SGML (Standardized Generalized Markup Language) is a text-based language for describing the content and structure of digital documents. For further information on an SGML file see, for example, SGML ISO 8879: 1986 Text and Office System-Standards Generalized Markup Language, Geneva, 1986.

In accordance with another aspect of the present invention, an animation can be played by a stand-alone animation player or be included by another Toolbook™ book.

In accordance with another aspect of the present invention, an animation specification is specified by drawing the paths of animation objects and setting their properties using an Animation Author which can be used to create and modify animations.

In accordance with another aspect of the present invention, an animation can be saved as a Toolbook™ book or an SGML file.

In accordance with another aspect of the present invention, an animation player in accordance with the principles of the invention provides VCR-type control of playing pre-saved animations.

It is an object of the present invention, to provide an animation with orientation wherein an animation object changes its orientation in following its path during animation playback.

In accordance with another aspect of the present invention, animation scheduling provides for animation objects to be synchronized during playback.

In accordance with another aspect of the present invention, a fluid/pipe animation provides the animation effect of fluid flowing through a pipe.

In accordance with another aspect of the invention, a method for specifying animation by a computer, comprises: loading a first image into an Animation Author for display on a display screen; entering an animation object into the animation author; entering into the animation author an animation path for the animation object from a starting position to an end position; and entering into the Animation Author a playback speed for playback of the animation.

In accordance with another aspect of the invention, a method for specifying animation comprises repeating foregoing steps for each animation object of the animation.

In accordance with another aspect of the invention, a method for specifying animation comprises the step of saving the animation as a Toolbook™ book.

In accordance with another aspect of the invention, a method for specifying animation comprises the step of saving the animation as an SGML (Standardized Generalized Markup Language) file.

In accordance with another aspect of the invention, a method for specifying animation comprises the steps of: calculating a new orientation for the animation object as a function of position of the animation object on the animation path; and orienting the animation object to the new orientation during the animation.

In accordance with another aspect of the invention, the step of calculating a new orientation comprises: representing the animation path as a series of sampling points; at each given sampling point, calculating a deviation by comparing coordinates of the given sampling point with coordinates of the next sampling point of the series; comparing the deviation with a predetermined limit; and recalculating the orientation whenever the deviation exceeds the predetermined limit.

In accordance with another aspect of the invention, a method for specifying animation, comprises the steps of: interactively entering an animation object into an animation authoring tool; entering an animation path for the object; and specifying animation of the object with orientation as a function of the animation path.

In accordance with another aspect of the invention, a method for specifying animation, comprises the steps of: interactively entering an animation object comprising a pipe into an animation authoring tool; specifying a fill color for the pipe; and specifying the fill color to start filling the pipe at a beginning point thereof at the start of the animation and to fill the pipe to an ending point thereof at the end of the animation.

In accordance with another aspect of the invention, a method for specifying animation, comprises the steps of: interactively entering a plurality of animation objects into an animation array in an animation authoring tool; storing properties associated with each of the animation objects in the animation array, including pre-conditions and post-conditions thereof; and scheduling the animation by an algorithm that checks each entry of an object of the plurality in the animation array and starts the object when its pre-condition is satisfied and signals the object in its post-condition.

In accordance with another aspect of the invention, apparatus comprises a computer for providing animation of an animation object by the functions including: interactively entering an animation object into an animation authoring tool; entering an animation path for the object; specifying animation of the object with orientation as a function of the animation path; selectively entering a pipe animation object into an animation authoring tool; specifying a fill color for the pipe; specifying the fill color to start filling the pipe at a beginning point thereof at the start of the animation and to fill the pipe to an ending point thereof at the end of the animation; selectively entering a plurality of animation objects into an animation array in an animation authoring tool; storing properties associated with each of the animation objects in the animation array, including pre-conditions and post-conditions thereof; and scheduling the animation by an algorithm that checks each entry of an object of the plurality in the animation array and starts the object when its pre-condition is satisfied and signals the object in its post-condition.

In accordance with another aspect of the invention, apparatus comprises a computer for providing animation of an animation object including: apparatus for interactively entering an animation object into an animation authoring tool; said apparatus entering an animation path for the object; specifying animation of the object with orientation as a function of the animation path; selectively entering a pipe animation object into an animation authoring tool; specifying a fill color for the pipe; apparatus for specifying the fill color to start filling the pipe at a beginning point thereof at the start of the animation and to fill the pipe to an ending point thereof at the end of the animation; selectively entering a plurality of animation objects into an animation array in an animation authoring tool; apparatus for storing properties associated with each of the animation objects in the animation array, including pre-conditions and post-conditions thereof; and scheduling the animation by an algorithm that checks each entry of an object of the plurality in the animation array and starts the object when its pre-condition is satisfied and signals the object in its post-condition.

In accordance with another aspect of the invention, apparatus comprises a computer for specifying animation, comprising: apparatus for loading a first image into an animation author for display on a display screen; apparatus for entering an animation object into the animation author; apparatus for entering into the Animation Author an animation path for the animation object from a starting position to an end position; and apparatus for entering into the Animation Author a playback speed for playback of the animation.

### BRIEF DESCRIPTION OF THE SEVERAL VIEWS OF THE DRAWINGS

The foregoing aspects of the present invention, and other aspects to be introduced and explained below, will be more fully understood from the following detailed description of the preferred embodiments of the invention, in conjunction with the drawings, in which

FIG. 1 shows an image of an object as seen in the animation editing tool in accordance with the principles of the invention;

FIG. 2 shows an illustration of an animation player in accordance with the principles of the invention;

FIG. 3 shows an example of an orientation process in accordance with the principles of the invention;

FIG. 4 shows an example of a scheduling process in accordance with the principles of the invention;

FIG. 5 shows an example of a pipe process in accordance with the principles of the invention; and

FIG. 6 shows an illustration of a fluid pipe animation in accordance with the principles of the invention.

### DETAILED DESCRIPTION OF THE INVENTION

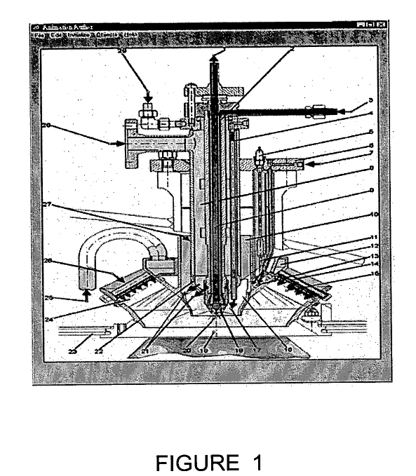

Animation in accordance with an embodiment of the present invention is specified using an animation editing tool shown by the exemplary embodiment in FIG. 1. The so-called Animation Author provides functionality for creating animation objects, drawing their paths, editing animation objects' properties, and opening/creating animation files.

Animation is drawn on top of a background image loaded into the Animation Author. An animation object is entered by the user, which may be by the user specifying and/or creating the animation object. For example, the animation object can be a user-drawn polygon. The user then draws the animation path of the object from its starting position to its end position. The speed of playback of the animation object can be adjusted. The process is repeated for each animation object of the animation being currently edited.

In Toolbook™'s animation framework, an object is always in its initial orientation during the playback. As a result, for example, a right arrow animation object still points to the right even during a time when the object is moving downwards. In accordance with the present invention, animation can be played with desired orientation. For example, an arrow object's arrow can always point to the direction in which it is moving.

Animation can be played in normal mode or in scheduling mode. In normal mode, each object is played at its own pace, without a requirement of knowledge of other animation objects. While in scheduling mode, objects are synchronized based on the user's specification.

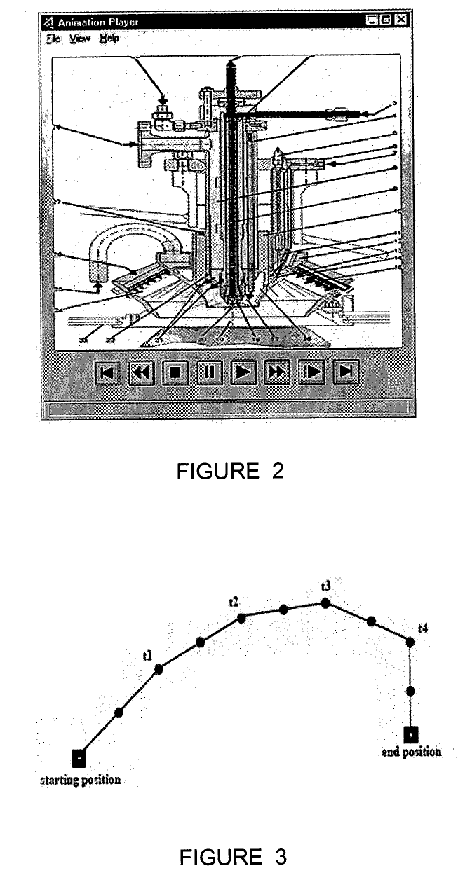

In accordance with an embodiment of the present invention, a new type of animation. called fluid/type is supported. For this type of animation, the user basically draws two paths to compose a pipe. A fill-in color is then specified. The animation starts at the beginning of the pipe and moves toward the end of pipe by filling the pipe with the specified color. Once an animation is specified by drawing, it can be modified by editing an animation array which is an enhanced data structure provided by Toolbook™. Each animation object has an entry in this array and all its properties are stored associated with this entry. This animation array serves as the structure where all processing steps are performed. Once an animation is specified, it can be saved either in Toolbook™ format (a file with extension ‘anm’) or in SGML format. Either format can be loaded by the animation player shown in FIG. 2. The animation player provides typical VCR (Video Cassette Recorder)-type controls for playing animations. The principles of orientation, scheduling, and fluid/pipe are described next.

As shown in FIG. 3, depending on the speed of playback of an animation object, its path can be represented as a number of sampling points. At each sampling point, the deviation thereof is calculated by comparing its coordinate with that of the next point. Thus the new orientation can be calculated and the animation object orientation be rotated accordingly. Note that the bounding box of an animation object has to be recalculated in this rotation. In FIG. 3, at sampling points t1, t2, 13, and t4, the animation object's orientation is changed because the deviation has exceeded a certain limit.

By default, every animation object has a pre-condition and post-condition, which are null initially. Each object also has three statuses: READY, RUN, and DONE. They represent respectively, an object in its initial condition, animation being played, and animation being finished.

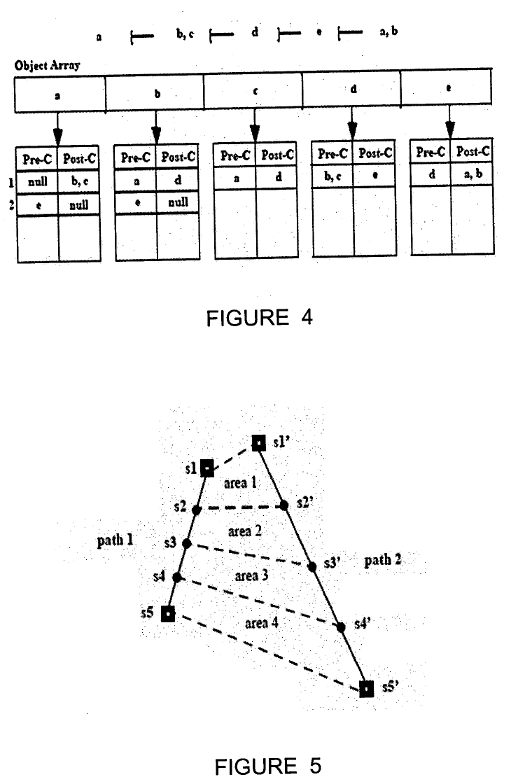

FIG. 4 shows an example of a scheduling process, in which the following scenario is described. Object ‘a’ starts playing first. Upon its finish, objects ‘b’ and ‘c’ start to play. When both of ‘b’ and ‘c’ are finished playing, object ‘d’ starts to play. Object ‘e’ starts to play after ‘d’ is finished. Then, objects ‘a’ and ‘b’ start to play again when ‘e’ is finished. Once the animation is specified, the object arrays are as shown. For object ‘a’, there are two “pre-conditions” and “post-conditions”. The first set defines that the object “a” is started once the animation starts, since its pre-condition is ‘null”; and its post-condition “b, c” specifies that objects ‘b’ and ‘c’ are started immediately when ‘a’ has stopped. The second entry for ‘a’ states that its pre-condition is ‘e’ so that ‘a’ will be played again when ‘e’ has finished and post-condition ‘null’ means that no animation object is started when ‘a’ is stopped this time.

The algorithm for scheduling basically checks each entry of an object array and starts an object when its pre-condition is satisfied and signals to the object in its post-condition. Thus each animation object is fired/played accordingly.

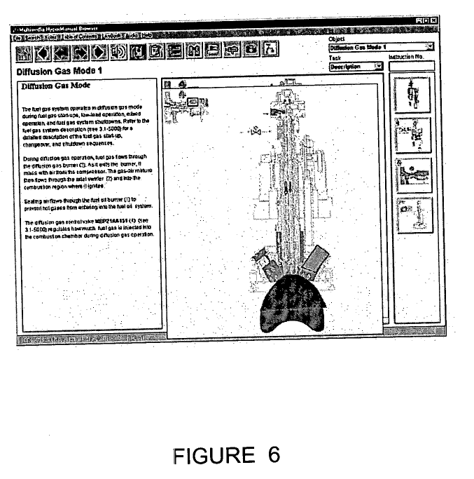

To achieve the fluid/pipe animation, the user has to specify two paths first, as shown in FIG. 5. Also the fill-in color is specified. Based on the speed of animation playback, the algorithm first calculates the same number of synchronization points (s1, s1′, etc.) along each path. Then, during animation playback, the process fills in one area at a time, from one end towards the other end. There are five synchronization points in each path in the example in FIG. 5. Thus four areas, area 1 to area 4, are filled-in sequentially. A fluid/pipe animation being played is shown in FIG. 6. Note that this animation is included in another Toolbook™ book.

As will be understood, the invention is intended for implementation by a computer, preferably a programmable digital computer.

While the invention has been described by way of exemplary embodiments, it will be understood by one of skill in the art to which it pertains that various changes, substitutions, and modifications may be made without departing from the spirit of the invention which is defined by the claims following.

1. A method for specifying animation by a computer, comprising the steps of:
loading a first image into an animation author for display on a display screen;
entering an animation object into said animation author;
entering into said animation author an animation path for said animation object from a starting position to an end position; and
entering into said animation author a playback speed for playback of said animation.

2. A method for specifying animation as recited in claim 1, comprising repeating foregoing steps for each animation object of said animation.

3. A method for specifying animation as recited in claim 1, comprising the step of saving said animation as a Toolbook™ book.

4. A method for specifying animation as recited in claim 1, comprising the step of saving said animation as an SGML (Standardized Generalized Markup Language) file.

5. A method for specifying animation as recited in claim 1, comprising the steps of:
calculating a new orientation for said animation object as a function of position of said animation object on said animation path; and
orienting said animation object to said new orientation during said animation.

6. A method for specifying animation as recited in claim 5, wherein said step of calculating a new orientation comprises:
representing said animation path as a series of sampling points;
at each given sampling point, calculating a deviation by comparing coordinates of said given sampling point with coordinates of the next sampling point of said series;
comparing said deviation with a predetermined limit; and
recalculating said orientation whenever said deviation exceeds said predetermined limit.

7. A method for specifying animation as recited in claim 1, comprising the steps of:
forming a boundary box for said animation object;
calculating a new orientation for said boundary box as a function of position of said animation object on said animation path; and
orienting said boundary box to said new orientation during said animation.

8. A method for specifying animation as recited in claim 7, wherein said step of calculating a new orientation comprises:
representing said animation path as a series of sampling points;
at each given sampling point, calculating a deviation by comparing coordinates of said given sampling point with coordinates of the next sampling point of said series;
comparing said deviation with a predetermined limit; and
recalculating said orientation whenever said deviation exceeds said predetermined limit.

9. A method for specifying animation as recited in claim 4, wherein said step of calculating a new orientation comprises:
representing said animation path as a series of sampling points;
at each given sampling point, calculating a deviation by comparing coordinates of said given sampling point with coordinates of said next point;
comparing said deviation with a predetermined limit; and
recalculating said orientation whenever said deviation exceeds said predetermined limit.

10. A method for specifying animation as recited in claim 1, comprising the steps of:
specifying said animation to play in one of:
(a) a normal mode; and
(b) a scheduling mode.

11. A method for specifying animation as recited in claim 10, wherein said step of specifying said animation to play in said normal mode comprises:
specifying a playing pace for said animation for causing said animation to play at its own specified pace substantially independently of any other animation objects.

12. A method for specifying animation as recited in claim 10, wherein said step of specifying said animation to play in said scheduling mode comprises:
specifying a playing pace for said animation for causing said animation to play at a synchronized pace based on a user specification.

13. A method for specifying animation as recited in claim 1, wherein said steps of loading a first image and of entering an animation object into said animation author comprise a step of using Toolbook™ for implementing said steps.

14. A method for specifying animation as recited in claim 10, comprising a step of specifying said animation for playing on a stand-alone animation player.

15. A method for specifying animation as recited in claim 13, comprising a step of specifying said animation for inclusion by another Toolbook™ book.

16. A method for specifying animation as recited in claim 1, wherein said step of entering an animation object comprises:
entering said animation object into an animation array.

17. A method for specifying animation as recited in claim 16, wherein said step of entering an animation object comprises:
storing properties associated with said animation object in said animation array.

18. A method for specifying animation as recited in claim 16, wherein said step of entering an animation object comprises:
modifying, when necessary, said animation object in said animation array.

19. A method for specifying animation as recited in claim 1, wherein said step of entering an animation object comprises:
entering said animation object into an animation array in an enhanced data structure provided by Toolbook™.

20. A method for specifying animation illustration as recited in claim 19, wherein said step of entering an animation object comprises:
storing properties associated with said animation object in said animation array.

21. A method for specifying animation as recited in claim 19, wherein said step of entering an animation object comprises:
modifying, when necessary, said animation object in said animation array.

22. A method for specifying animation as recited in claim 1, wherein said step of entering an animation object comprises:
entering first and second paths for composing a pipe; and
specifying a fill-in color for said pipe.

23. A method for specifying animation as recited in claim 22, wherein said step of entering into said animation author an animation path comprises:
specifying said starting position and said end position as a beginning point and an end point for said pipe, respectively.

24. A method for specifying animation as recited in claim 23, wherein said animation is specified such that said animation starts at beginning point and ends at said end point for said pipe.

25. A method for specifying animation as recited in claim 1, comprising:
specifying a default condition for said animation object to have a pre-condition and a post-condition;
specifying a default condition for said animation object such that said pre-condition and a post-condition are null initially; and
specifying a default condition for said animation object to have statuses of READY, RUN, and DONE.

26. A method for specifying animation as recited in claim 25, comprising:
scheduling said animation by an algorithm that checks each entry of an object in said animation array and starts said object when its pre-condition is satisfied and signals said object in its post-condition.

27. A method for specifying animation, comprising the steps of:
interactively entering an animation object into an animation authoring tool;
entering an animation path for said object; and
specifying animation of said object with orientation as a function of said animation path.

28. A method for specifying animation, comprising the steps of:
interactively entering an animation object comprising a pipe into an animation authoring tool;
specifying a fill color for said pipe; and
specifying said fill color to start filling said pipe at a beginning point thereof at the start of said animation and to fill said pipe to an ending point thereof at the end of said animation.

29. A method for specifying animation, comprising the steps of:
interactively entering a plurality of animation objects into an animation array in an animation authoring tool;
storing properties associated with each of said animation objects in said animation array, including pre-conditions and post-conditions thereof; and
scheduling said animation by an algorithm that checks each entry of an object of said plurality in said animation array and starts said object when its pre-condition is satisfied and signals said object in its post-condition.

30. Apparatus comprising a computer means for providing animation of an animation object by the functions including:
interactively entering an animation object into an animation authoring tool;
entering an animation path for said object;
specifying animation of said object with orientation as a function of said animation path;
selectively entering a pipe animation object into an animation authoring tool;
specifying a fill color for said pipe;
specifying said fill color to start filling said pipe at a beginning point thereof at the start of said animation and to fill said pipe to an ending point thereof at the end of said animation;
selectively entering a plurality of animation objects into an animation array in an animation authoring tool;
storing properties associated with each of said animation objects in said animation array, including pre-conditions and post-conditions thereof; and
scheduling said animation by an algorithm that checks each entry of an object of said plurality in said animation array and starts said object when its pre-condition is satisfied and signals said object in its post-condition.

31. Apparatus comprising a computer means for providing animation of an animation object including:
means for interactively entering an animation object into an animation authoring tool;
means for entering an animation path for said object;
means for specifying animation of said object with orientation as a function of said animation path;
means for selectively entering a pipe animation object into an animation authoring tool;
means for specifying a fill color for said pipe;
means for specifying said fill color to start filling said pipe at a beginning point thereof at the start of said animation and to fill said pipe to an ending point thereof at the end of said animation;
means for selectively entering a plurality of animation objects into an animation array in an animation authoring tool;
means for storing properties associated with each of said animation objects in said animation array, including pre-conditions and post-conditions thereof; and
means for scheduling said animation by an algorithm that checks each entry of an object of said plurality in said animation array and starts said object when its pre-condition is satisfied and signals said object in its post-condition.

32. Apparatus comprising a computer means for specifying animation, comprising:
means for loading a first image into an animation author for display on a display screen;
means for entering an animation object into said animation author;
means for entering into said animation author an animation path for said animation object from a starting position to an end position; and
means for entering into said animation author a playback speed for playback of said animation.
